(19) United States
(12) Patent Application Publication
(10) Pub. No.: US 2018/0161739 A1
(43) Pub. Date: Jun. 14, 2018

(54) MIXER WITH IMPINGING CO-AXIAL STREAMS

(71) Applicant: Gas Technology Institute, Des Plaines, IL (US)

(72) Inventors: Jeffrey A. MAYS, Woodland Hills, CA (US); John C. Vega, III, Camarillo, CA (US); Anthony Eastland, Moorpark, CA (US)

(73) Assignee: Gas Technology Institute, Des Plaines, IL (US)

(21) Appl. No.: 15/837,940

(22) Filed: Dec. 11, 2017

Related U.S. Application Data
(60) Provisional application No. 62/431,950, filed on Dec. 9, 2016.

(51) Int. Cl. B01F 5/04; B01F 3/02

(52) U.S. Cl. CPC B01F 5/0471; B01F 2215/0085; B01F 3/026

(57) ABSTRACT

A mixer for separate streams of gas includes a center stream of a first gas and a co-axial stream of a second gas injected at an angle to the center stream and filling an annulus around the center stream. The mixer may further include a feed zone wherein the first gas is introduced into the mixer as the center stream and the second gas is introduced into the mixer as the co-axial stream filling the annulus around the center stream; a mixing zone wherein the first gas and the second gas mix with no recirculation zones to form a mixture; and a diffusion zone for advancing the mixture from the mixing zone. Corresponding or associated methods for mixing materials are also provided.

### CROSS REFERENCE TO RELATED APPLICATION

This application claims the benefit of U.S. Provisional Application Ser. No. 62/431,950, filed on 9 Dec. 2016. The co-pending Provisional Patent Application is hereby incorporated by reference herein in its entirety and is made a part hereto, including but not limited to those portions which specifically appear hereinafter.

### BACKGROUND OF THE INVENTION

### Field of the Invention

This invention relates generally to a mixing and, more particularly, to devices and methods that desirably produce or result in rapid, complete mixing in a short distance and/or time.

### Description of Related Art

Mixing of components or ingredients is involved in many chemical processing systems and arrangements. For example, a combustible mixture can be created by mixing two components or reactants such as a fuel and an oxidant. If the velocity is high and there are no stagnation/recirculation zones, the mix will not have sufficient time to ignite and burn. Current techniques, however, may lead to unintended combustion. One such current mixing technique is a jet in a crossflow. This has not shown to be sufficient to date. Preferred mix processing desirably produces, achieves or results in rapid mixing to a uniform mixture with no recirculation zones.

### SUMMARY OF THE INVENTION

An impinging co-axial mixer according to a preferred embodiment of this invention produces or results in rapid, complete mixing in a very short distance/time for chemical processing. It is preferably a mixer for separate streams with particular application to gas-to-gas mixing. It works by mixing two streams: (1) one stream is a center stream: and (2) a second stream co-axially filling an annulus around the central stream.

In accordance with another aspect of the subject invention, a method for co-axially mixing separate streams of gas in provided. In one preferred embodiment, such a method involves introducing a first gas as a center stream in a co-axial mixer. A second gas is introduced as a co-axial stream at an angle to the center stream and fills an annulus around the center stream. The first and second gases are mixed to form a mixture with no recirculation zones.

### BRIEF DESCRIPTION OF THE DRAWINGS

Objects and features of this invention will be better understood from the following description taken in conjunction with the drawings, wherein:

FIG. 1 is a simplified schematic showing a mixer in accordance with aspect of the subject invention.

### DETAILED DESCRIPTION

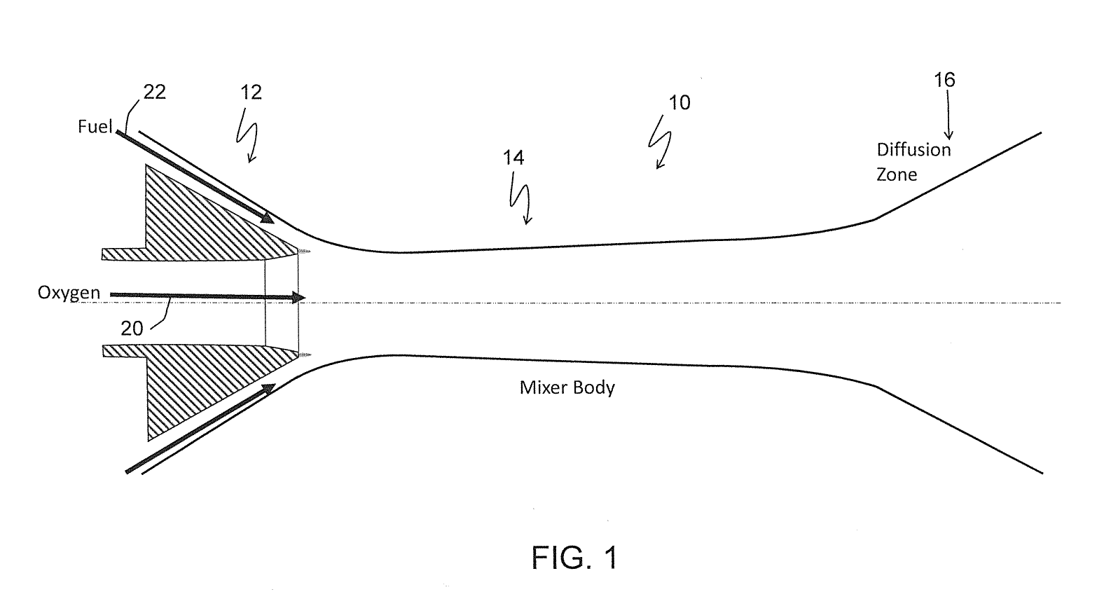

As shown in FIG. 1, an impinging co-axial mixer according to a preferred embodiment preferably includes a mixer, generally designated by the reference numeral 10, for separate streams with particular application to gas-to-gas mixing. The mixer 10 generally includes a feed or introduction zone 12 wherein feed materials or components are fed or introduced into the mixer 10, a mixing zone 14 wherein feed materials or components introduced into the mixer 10 are appropriately combined and mixed and a diffusion zone 16 wherein the mixture of materials or components resulting from the mixing zone 14 are appropriately advanced. The mixer 10 works by mixing two streams: (1) a first stream 20, e.g., a center stream; and (2) a second stream 22 coaxially filling an annulus around the central stream as shown in the attached schematic.

While mixer 10 shown in FIG. 1 illustrates the first or center stream 20 as composed of oxygen and the second or annulus stream 22 as composed of fuel, those skilled in the art and guided by the teaching herein provided will understand and appreciate that the broader practice of the subject development is not necessarily so limited.

In addition to mixing driven by different velocities of the two streams such as may be typical of co-axial mixers, with an impinging co-axial mixer in accordance with the subject development, an angle to the flow of the annular stream such as directing the annular stream into the central stream can be suitably selected and tailored such as to desirably enhance the resulting mixing. Also, the shape of the mixing zone can be varied to inhibit recirculation. Thus, in accordance with a preferred aspect of the invention, the mixer and processing of the invention result or produce rapid mixing to a uniform mixture with no recirculation zones.

While in the foregoing specification the subject development has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A mixer for separate streams of gas comprising:
a center stream of a first gas; and
a co-axial stream of a second gas injected at an angle to the center stream and filling an annulus around the center stream.

2. The mixer of claim 1, wherein the mixer includes:
a feed zone wherein the first gas is introduced into the mixer as the center stream and the second gas is introduced into the mixer as the co-axial stream filling the annulus around the center stream;
a mixing zone wherein the first gas and the second gas mix with no recirculation zones to form a mixture; and
a diffusion zone for advancing the mixture from the mixing zone.

3. The mixer of claim 1 wherein the first gas is oxygen.

4. The mixer of claim 1 wherein the second gas is a fuel gas.

5. The mixer of claim 1 wherein the angle of injection of the second gas injected to the center stream is selected to enhance mixing.

6. A method for co-axially mixing separate streams of gas, the method comprising:
introducing a first gas as a center stream in a co-axial mixer,
introducing a second gas as a co-axial stream at an angle to the center stream and filling an annulus around the center stream, and
mixing the first and second gases to form a mixture with no recirculation zones.
